(19) United States
(12) Patent Application Publication
(10) Pub. No.: US 2022/0339778 A1
(43) Pub. Date: Oct. 27, 2022

(54) BODY WEIGHT SUPPORT SYSTEM FOR EXOSKELETONS AND METHOD OF USING THE SAME

(71) Applicant: MAWASHI SCIENCE & TECHNOLOGY INC., Saint-Jean-sur-Richelieu (CA)

(72) Inventor: Alain BUJOLD, Dollard-des-Ormeaux (CA)

(73) Assignee: MAWASHI SCIENCE & TECHNOLOGY INC., Saint-Jean-sur-Richelieu, QC (CA)

(21) Appl. No.: 17/608,023

(22) PCT Filed: May 1, 2020
(86) PCT No.: PCT/CA2020/050580

§ 371 Date: Nov. 1, 2021

Related U.S. Application Data
(60) Provisional application No. 62/841,898, filed on May 2, 2019.

(51) Int. Cl. B25J 9/00

(52) U.S. Cl. CPC B25J 9/0006

(57) ABSTRACT

A body weight support system configured to be worn by a user is provided. The support system comprises for instance a leg support system and optionally a sacral support system, and a passive actuation system, in order to partially support and transfer the user's body weight down to the ground surface. The support system is intended to connect to a load bearing structure worn by the user, such as an exoskeleton, for at least partially supporting and transferring the body weight normally carried in its entirety by the user, to the ground surface, thereby reducing the load effectively supported by the users themselves. The present invention provides passive assistance to the hip movement to facilitate leg movements and in turn reduce the effort required by the individual during locomotion. The body wear support system contributes to the decrease of the energetic cost or consumption of locomotion by user.

### CROSS REFERENCE TO RELATED APPLICATIONS

The present patent application claims the benefits of priority of U.S. Provisional Patent Application No. 62/841,898, untitled “Body weight support system, method of using the same and exoskeleton using the same”, filed at the United States Patent and Trademark Office on May 2, 2019, the content of which is incorporated herein by reference.

### TECHNICAL FIELD

The present invention generally relates to a body weight support system and a method of using the same in collaboration with exoskeletons or other wearable structures configured to support the body weight of a user and assist the user in carrying loads.

### BACKGROUND

Devices, such as exoskeletons, for assisting users carrying heavy loads and during locomotion have long been a need in many circumstances. For example, soldiers in the field, firefighters, police officers, antiriot squads, but also construction workers, and hikers, are often faced with the problem of carrying heavy loads, sometimes over long distances.

In several domains, however, namely defense, outdoor, industrial, logistics, construction and medical/rehabilitation sectors, during bipedal locomotion, the user also needs to displace the weight of their own body, which requires metabolic energy.

Several researchers have studied the human locomotion and were able to divide the human walking and running in biomechanical tasks. For instance, the net metabolic cost of running can be partitioned into the biomechanical tasks of: 1) body weight support, 2) forward propulsion, 3) leg-swing, 4) lateral balance, and 5) arm-swing (see for example, Arellano, C. J., & Kram, R. (2014) “Partitioning the metabolic cost of human running: a task-by-task approach”. Integrative and comparative biology, 54(6), 1084-98).

Among these biomechanical tasks, it was estimated that body weight support comprises approximately 74% of the net metabolic cost of running (see Teunissen L P, Grabowski A, Kram R. “Effects of independently altering body weight and body mass on the metabolic cost of running”. J Exp Biol. 2007; 210 (Pt 24):4418-27). Another study found that reducing body weight decreases the net metabolic rate. More precisely, the analysis deduced that the task of generating force to support body weight comprises approximately 28% of the metabolic cost of normal walking.

Although some exoskeletons address the problem of carrying the load supported by a user, the problem of the user carrying the weight of their own human body is not addressed in these exoskeletons.

Accordingly, there is a need for an additional, alternative, and/or improved body weight support system, to complement non-powered load-carrying exoskeletons, that dynamically and/or statically supports a portion of the body weight of the user in order to facilitate human locomotion.

### SUMMARY

In accordance with the present disclosure, there is provided a support system for supporting a body weight of a user configured to be attached to a load bearing structure worn by the user to assist the user in carrying a load by transferring the load down to the ground. The support system is configured to connect the user's body to the load bearing structure for at least partially supporting the user's body weight by transferring the user's body weight to the ground through the load bearing structure. When the user is standing up along a vertical direction, the support system connects at least one first point of connection on the user's body to at least one second point of connection on the load bearing structure, with each first point of connection being lower than each second point of connection in order to create an upward force along the vertical direction between the user's body and the load bearing structure for reducing an energetic cost of locomotion of the user wearing the load bearing structure.

According to a preferred embodiment, the load bearing structure is an exoskeleton comprising at least a hip section operatively connected to a leg section, the support system comprising: at least one leg support configured to connect a leg of the user with the hip section of the load bearing structure. Preferably, the support system comprises: a pair of said at least one leg support, each leg support connecting one of the legs of the user to the hip section of the load bearing structure.

According to a preferred embodiment, each leg support is configured to provide the first point of connection with the foot, the calf or the thigh of the leg.

According to another preferred embodiment, each leg support is configured to provide a plurality of said first point of connection with the foot, the calf and/or the thigh of the leg.

According to another preferred embodiment, each of the leg supports comprises a supporting element configured to be connected to the respective user's leg, and a connecting element extending from the supporting element to connect the supporting element with the load bearing structure. Preferably, the connecting element comprises a connecting strap having an adjustable length.

According to another preferred embodiment, each supporting element comprises a flexible material configured for at least partially wrapping the user's leg for supporting the leg. Preferably, each of the leg supports comprises a flexible polymeric material. More preferably, each of the leg supports has a mesh structure made of the flexible polymeric material.

According to another preferred embodiment, the support system as disclosed herein may comprise an elastic medium for storing potential energy during a loading response and a mid stance of a human gait.

According to another preferred embodiment, the support system may further comprise: a sacral support configured to be received between the user's legs between a front portion and a back portion of the user where the sacral support connects, preferably removably connects to the load bearing structure. The sacral support may connect to the hip section at four connection locations of the hip section. More preferably, the sacral support connects, preferably removably connects to the hip section at two connection locations of the front portion and at two connection locations of the back portion of the hip section. The sacral support may comprise a textile material.

According to another preferred embodiment, the support system further comprises: at least one elastic mechanism, each elastic mechanism being configured for connecting the leg section to the hip section of the exoskeleton in order to store energy during different gait phases of the user. Preferably, each of the elastic mechanisms are formed of an elastic strap.

In accordance with the present disclosure, there is also provided a load bearing structure, such as an exoskeleton, configured to be worn by a user to assist the user in carrying a load by transferring the load down to the ground, wherein the load bearing structure comprises the support system as defined and disclosed herein, for connecting the user's body to the load bearing structure for at least partially supporting the user's body weight by transferring the user's body weight to the ground through the load bearing structure and as such reducing an energetic cost for locomotion.

In accordance with the present disclosure, there is also provided a method for reducing an energetic cost for locomotion of a user wearing a load bearing structure configured to assist the user in carrying a load by transferring the load down to the ground. The method comprises at least the step of: further wearing a support system configured to connect the user's body to the load bearing structure for at least partially supporting the user's body weight by transferring the user's body weight to the ground through the load bearing structure. When the user is standing up along a vertical direction, the support system allows connecting at least one first point of connection on the user's body to at least one second point of connection on the load bearing structure with each first point of connection being lower than each second point of connection in order to create an upward force along the vertical direction between the user's body and the load bearing structure.

According to a preferred embodiment, the support system comprises a pair of leg supports, each leg support being configured for being connected to one of the legs of the user, the method then comprising:

connecting each leg support to each leg; and

connecting each leg support to the load bearing structure.

According to a preferred embodiment, connecting each leg support to each leg comprises providing the first point of connection with the foot, the calf or the thigh of the leg.

According to a preferred embodiment, connecting each leg support to each leg comprises providing a plurality of said first point of connection with the foot, the calf and/or the thigh of the leg.

According to a preferred embodiment, each leg support is connected to the hip section of the load bearing structure with a connecting strap, the method further comprising:
adjusting a length of the strap in order to adjust said tension between the leg and the hip section.

According to a preferred embodiment, connecting each leg of the user comprises at least partially wrapping each leg support around one of the user's leg.

According to a preferred embodiment, the support system as disclosed herein may comprise an elastic medium, the method then further comprising storing potential energy during a loading response and a mid stance of a human gait.

According to a preferred embodiment, the method as disclosed herein further comprises:
providing a sacral support configured to be received between the user's legs; and
connecting the sacral support between a front portion and a back portion of the hip section of the load bearing structure.

According to a preferred embodiment, the sacral support is connected, preferably removably connected, to the hip section at two connection locations of the front portion and at two connection locations of the back portion of the hip section.

According to a preferred embodiment, the sacral support comprises a textile material.

According to a preferred embodiment, the load bearing structure further comprises a leg section operatively connected to the hip section, the method further comprising:
connecting the leg section to the hip section of the load bearing structure with at least one elastic mechanism in order to store energy during different gait phases of the user.

Preferably, each of the elastic mechanisms are formed of an elastic strap.

In accordance with the present disclosure, there is also provided the use of the body weight support system as described here in combination with a load bearing structure, such as an exoskeleton, configured to assist the user in carrying a load by transferring the load down to the ground, for reducing an energetic cost of locomotion of the user wearing such a combination.

The body wear support system according to the present invention contributes to the decrease of the energetic cost or consumption of locomotion by the user in combination with a load bearing structure (e.g. an exoskeleton).

### BRIEF DESCRIPTION OF DRAWINGS

The above and other aspects, features and advantages of the invention will become more readily apparent from the following description, reference being made to the accompanying drawings in which:

FIG. 1 depicts a user wearing a load-bearing structure, such as an exoskeleton, to which a body weight support system in accordance with the principles of the present invention is attached;

FIG. 2 is a front view of the leg support system including a passive actuation system in accordance with another embodiment of the present invention;

FIGS. 3a-3d are pictures showing the body weight support system in accordance with different embodiments of the present invention;

FIG. 4 are pictures of a pair of leg support systems in accordance with an embodiment of the present invention;

FIG. 5 illustrates the leg support system in accordance with another embodiment of the present invention;

FIGS. 6a-6d are different views of the body weight support system including a pair of leg supports, a sacral support and a passive actuation system in accordance with another embodiment of the present invention;

FIG. 7 shows in detail a sacral support system in accordance with an embodiment of the present invention;

FIG. 8 is a diagram showing the relationship between the % of weight support and energetic cost (EC) of locomotion for the leg support system in accordance with an embodiment of the present invention;

FIG. 9 is a diagram showing the relationship between the % of weight support and the energetic cost (EC) of locomotion for the sacral support system in accordance with an embodiment of the present invention;

FIG. 10 shows a front view a user wearing a load-bearing structure, such as an exoskeleton, with a body weight support system in accordance with a preferred embodiment

FIG. 11 shows a back view a user wearing a load-bearing structure, such as an exoskeleton, with a body weight support system in accordance with a preferred embodiment;

FIG. 12 shows a side view a user wearing a load-bearing structure, such as an exoskeleton, with a body weight support system in accordance with a preferred embodiment;

FIG. 13 shows a side view of a body weight support system in accordance with a preferred embodiment;

FIG. 14 shows a side view of a pair body weight support systems in accordance with a preferred embodiment;

FIG. 15 shows a front view of a weight support system in accordance with a preferred embodiment;

FIG. 16 shows a back view of the pair body weight support systems of FIG. 15;

FIG. 17 is a flowchart illustrating the method for reducing an energetic cost for locomotion of a user wearing a load bearing structure configured to assist the user in carrying a load by transferring the load down to the ground, in accordance with preferred embodiments of the invention; and

FIG. 18 is a flowchart illustrating a more preferred embodiment of the method illustrated on FIG. 17.

### DETAILED DESCRIPTION

A body weight support system for a load bearing structure is described. Although the invention is described in terms of specific illustrative embodiments, it is to be understood that the embodiments described herein are by way of example only and that the scope of the invention is not intended to be limited thereby.

The terminology used herein is in accordance with definitions set out below.

When used herein, by “about”, it is meant that the value of %, weight, time, length, volume or temperature can vary within a certain range depending on the margin of error of the method or device used to evaluate such weight %, weight, time, length, volume or temperature. A margin of error of 10% is generally accepted.

The description which follows, and the embodiments described therein are provided by way of illustration of an example of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals.

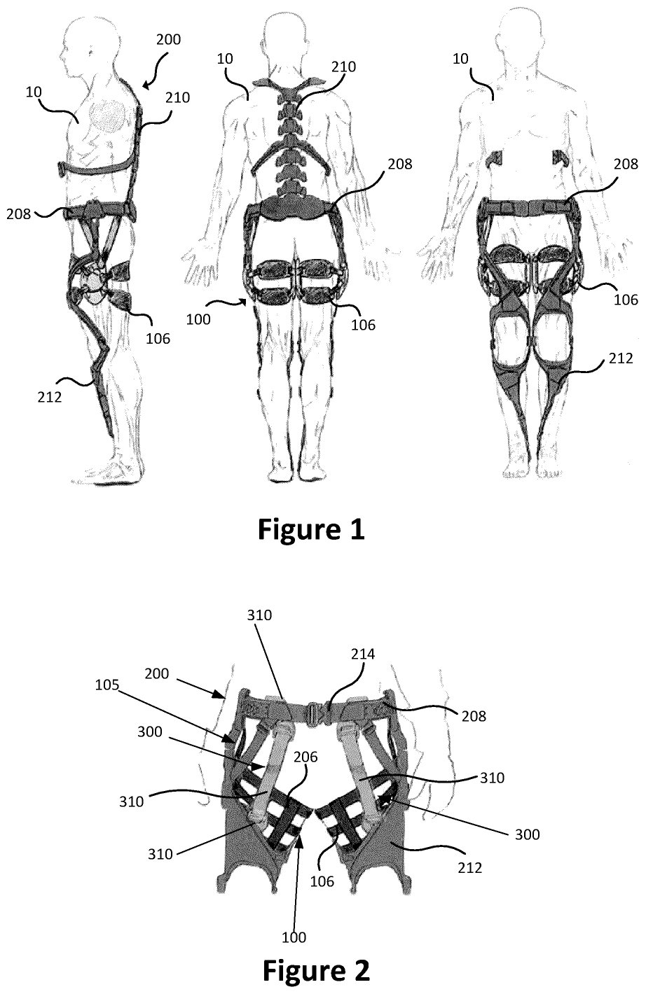

WO 2015/192240 A1, corresponding U.S. Pat. No. 9,492,300 by Bujold et al., the content of which being incorporated herein by reference, teaches a portable structure arrangement, known as an exoskeleton, developed by the applicant. As illustrated on FIG. 1, the exoskeleton is to be worn by a user (a human), to support and transfer a load supported by the upper section of the exoskeleton down to the ground. This exoskeleton (200) typically comprises at least three interconnected sections: a torso section (208), a leg section (212) and a hip section (208) connecting the torso and leg sections. Each of the sections generally comprises a plurality of interconnected rigid members which form the load-bearing structure of the exoskeleton. When a user wears the exoskeleton, the load normally carried by the head, neck and/or torso of the user is at least partially supported and transferred to the ground by the exoskeleton, thereby reducing the load effectively supported by the user itself. The leg sections of the exoskeleton are also particularly designed to ensure that the load-bearing final location is located on the inner side of the feet, in accordance with human biomechanics. Although the present invention is described herein in combination with the exoskeleton developed by the applicant and disclosed in U.S. Pat. No. 9,492,300 mentioned above, it has to be understood that the present invention can be used in combination with other exoskeletons or load bearing structures facilitating the locomotion of the user.

The body weight support system (BWSS), or simply “support system” herein after, in accordance with the preferred embodiments illustrated herein, is configured to be worn by a user wearing a load bearing structure to facilitate locomotion of the user. The support system may connect to the load bearing structure to support and partially transfer the body weight of the user, normally carried by the user, down to the ground in order to reduce the load effectively supported by the user themselves. The support system may also reduce the biomechanical energy spent by a user while in bipedal locomotion and may increase the user's endurance during bipedal locomotion. The support system is preferably worn at the legs and/or hips of the user and connected to the torso, hip and/or leg sections of the load bearing structure, inasmuch as the point of connection on the user's body is lower than the point of connection to the load bearing structure to provide an upward force on the user, as better illustrated and explained below.

In one embodiment, the body weight support system (BWSS) can be integrated to the exoskeleton. Therefore, the bodyweight support system could use the exoskeleton attachment mechanism as body weight support system structure. As well in one embodiment, the medium used to connect the bodyweight support system to the exoskeleton could be integrated inside the exoskeleton structure. The support system consists in supporting parts connected to the thighs and/or calves and/or feet. Also, the support system can uses parts that surrounds the legs or can use clamping parts that are attached to the legs (thigh, calves, and or feet). The BWSS could be attached on either the upper or belt system or lower part of the exoskeleton.

In one embodiment, the BWSS could be attached to the exoskeleton upper section, notably on the exoskeleton shoulder parts using suspenders.

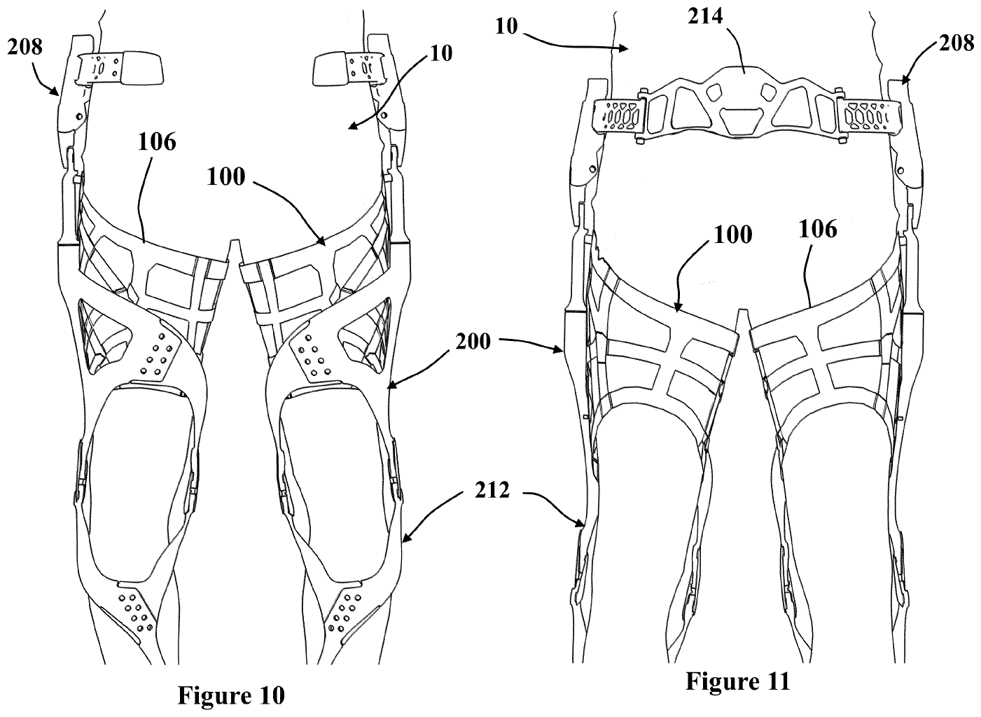

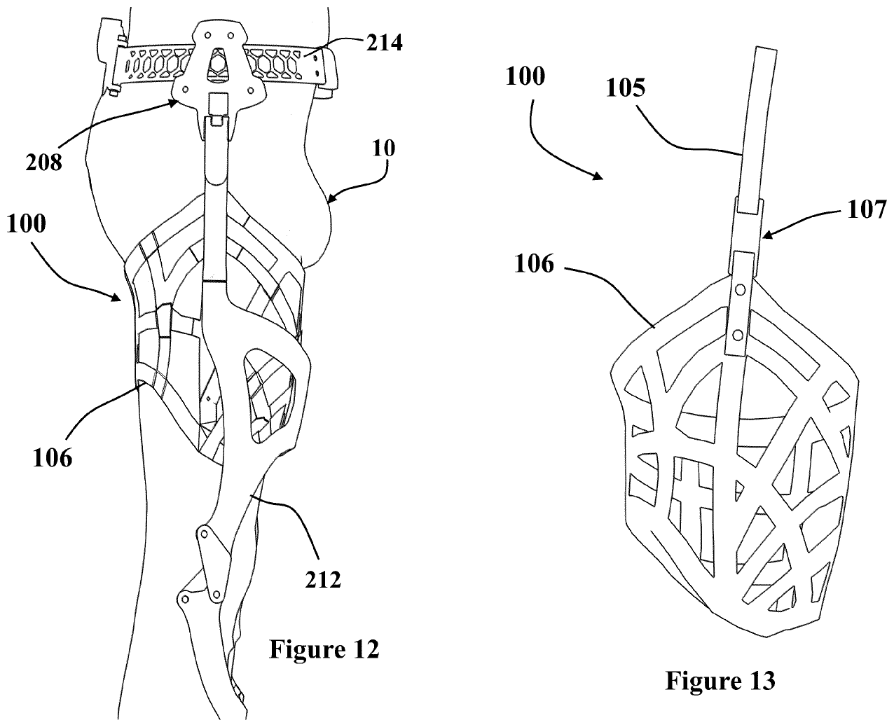

FIG. 1 depicts side, back, and front views of a user 10 wearing a load bearing structure 200, such as an exoskeleton, to which a body weight support system 100 is attached. FIGS. 10, 11 and 12 are a closer view of the exoskeleton and support system 100. It will be appreciated that the load bearing structure 200 may be a wearable device, an orthopedic/prosthetic device, or an exoskeleton type device. The body weight support system 100 is designed to be worn by the user 10 and connected to the load bearing structure 200. The load bearing structure of FIG. 1 or 10-12 is an exoskeleton comprising a torso section 210 (FIG. 1), a leg section 212, and a hip section 208 connecting the leg and torso sections. The torso section 210 rests on the shoulders of the user 10 and connects to the hip section 208. The hip section 208 may secure around the hips of the user 10 and may connect to the leg sections 212 at lateral sides of the user 10.

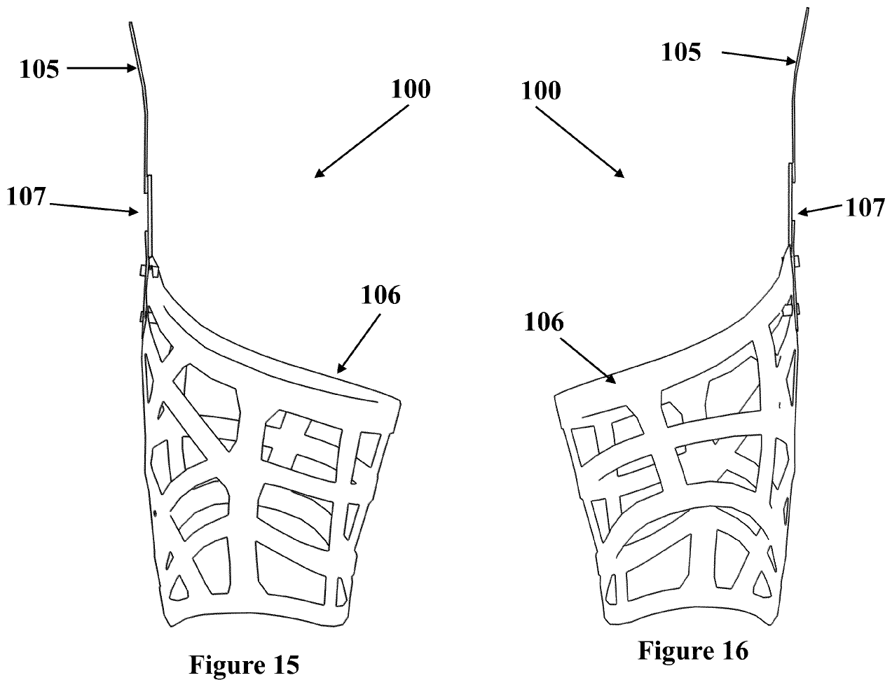

The body weight support system 100 in FIG. 1 comprises a leg support 106, such as for instance a leg harness slidingly received at each thigh of the user's legs for wrapping around the legs. Other configurations of the leg support will be described herein, for instance in reference to FIGS. 10 to 16.

As aforesaid, the leg support 106 provides an upward force on the leg of the user 102 when the user is standing up, because the point of connection on the user's body is lower than the point of connection to the load bearing structure creating as such an almost vertical tension between the two points of connections and an upward force on the user. The upward force is then transferred to the load bearing structure that is configured to transfer the force down to the ground. The own weight of the user is therefore partially supported by the load bearing structure when the user is standing up or during locomotion, by partially countering the gravity of the user body weight. The support system is also configured for not limiting the user's gait during locomotion. The points of connections can be between the lower body parts of the user such as the feet, the calves and/or the thighs (or the entire legs as shown on FIG. 5), and the hip or upper sections of the load bearing structure (e.g. exoskeleton) such as the belt at the hip section, the spine or shoulders. Another option would be a connection of the support system between the hips of the user and the upper section of the load bearing structure, such as for instance suspenders connected to the hips of the users and attached to the upper section of the load bearing structure.

As shown in the present examples, the leg supports 106 may be formed of a flexible polymeric material such as a nylon structure. This flexible polymeric material may prevent any discomfort or any creation of pressure points on the legs of the user 10 while the leg support 106 is being pulled upwards.

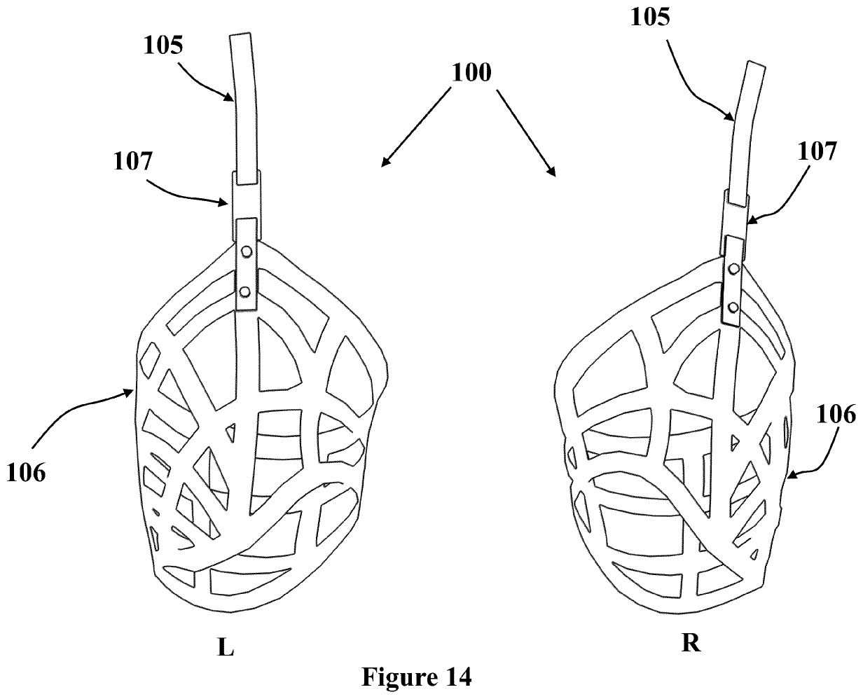

As aforesaid, the upward force is typically oriented upwards, opposite the gravitational force. In the Figures, the leg supports 106 provide the upward force by pulling up on the legs of the user 10. As better shown on FIGS. 13-16, the leg support 106 may comprise a connection means, such as a strap 105, at a side of the leg support 106 to connect the leg support 106 to the load bearing structure 200. To provide the upward force, the point of connection to the hip section 208 is above the leg support 106 connecting to the legs (e.g. the thighs) allowing the leg support 106 being pulled upwards towards the hip section 208. A portion of the body weight of the user 10 that is supported by the body weight support system 100 is then transferred to the hip section 208 of the load bearing structure or exoskeleton, then to the leg sections 212 and then to the ground.

The strap 105 for connecting the leg support 106 to the hip section 208 of the exoskeleton 200 has a length that is adjustable thanks to an adjusting mechanism 107. The mechanism can be a buckle, snaps or a Velcro® or any suitable length adjustment mechanism,

By partially unloading or supporting the user's body weight, the whole load carried by the users 10 themselves is reduced. The body weight support system 100 allows a user 10 to perform various tasks and duties without having to support the user's full body weight, which may allow for the user 10 to perform more tasks and may allow for the user to require less frequent breaks while performing the tasks. The body weight support system 100 may be integrated into the load bearing structure 200 worn by the user 10, or the body weight support system 100 may be a separate component that removably connects to the load bearing structure 200.

FIG. 2 depicts another embodiment of the body weight support system 100 comprising the support system 100 and a passive actuation system 300. The support system 100 comprises leg supports 106 and may connect to the hip section 208 of the load bearing structure 200. To facilitate connection of the leg supports 206 to the load bearing structure, the hip section 208 may comprise a belt 214 with connection means for connecting the leg supports 106 to the load bearing structure 200, as will be better described below. The belt 214 may further allow for adjustability of the load bearing structure at the hip section 208 to ensure that the load bearing structure is properly secured to the user 10.

The actuation system 300, preferably a passive (non-motorized) actuation system, to store biomechanical energy of the user during certain phases of locomotion and to restore the energy to the user during other phases of the locomotion cycle. For example, a passive actuation system may store energy during a stance phase of a gait cycle and restore energy during a swing phase of the gait cycle. The actuation system, which is preferably a passive actuation system, may be integrated into the load bearing structure or may be separate components that connect to the load bearing structure.

The actuation system 300 as illustrated herein comprises an elastic mechanism 310 that connects at one end, to the hip section 208 and at the opposite end, to the leg section 212 of the load bearing structure 200. As depicted in FIG. 2, there is an elastic element 218 for each leg of the user. The elastic element of FIG. 2 is an elastic strap 310 and can be connected to the belt 214 of the hip section 208. Its function is similar to a suspender or garter belt in which the connection of the elastic strap 310 to the load bearing structure may be via a belt 214 of the hip section 208, or directly to the hip section 208. The location of the elastic element 310 on the load bearing structure, relative to the user, is designed so that the elastic element 310 does not affect the user's ease and range of motion during locomotion and other positions or maneuvers while wearing the body weight support system 100. The elastic element 310 may comprise the elastic strap 310 and connection means 320 at each end of the strap. The elastic strap may, for example, be a band made of natural rubber. The connection means may be a belt type connection, a snap type connection, or another connection means.

To allow the actuation system 300 to be used with various load bearing structures and with various users, the length and tension of the elastic strap 310 can be adjusted. This means that the strap 310 can be adjusted to be used for users of varying heights and for various load bearing structure designs to temporarily store energy at specific gait phases of the user. If the tension of the elastic strap 310 is not sufficient to store energy or the strap is too loose/tight, the elastic strap 310 may not store and restore energy to the user, and may restrict movement of the user during locomotion.

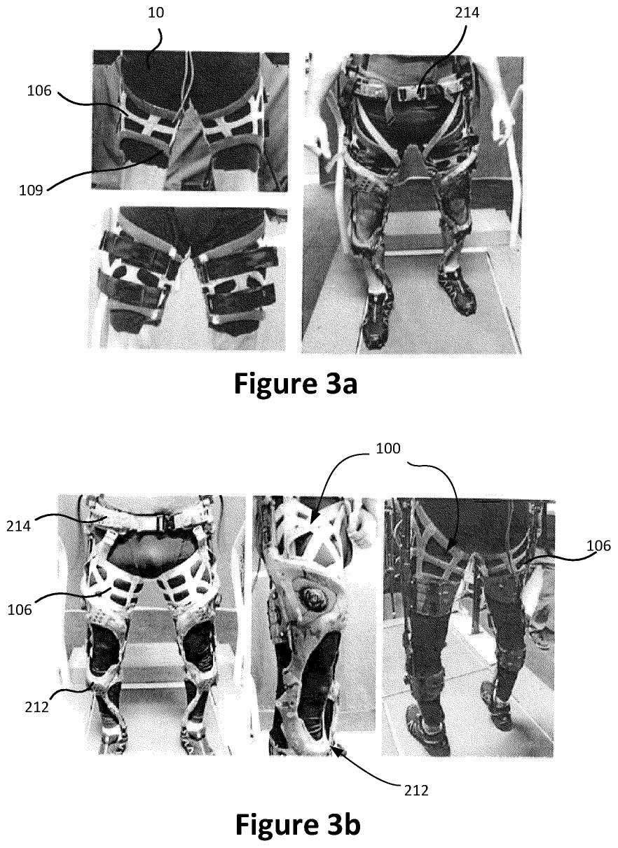

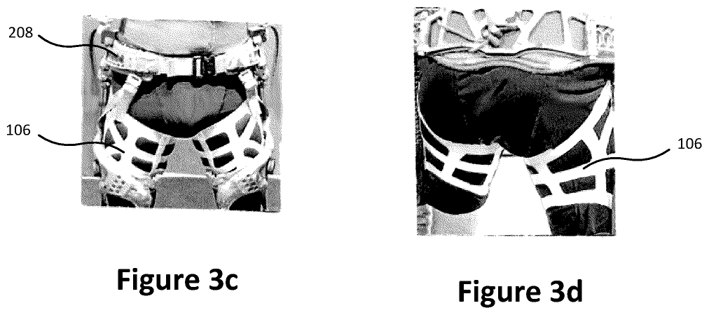

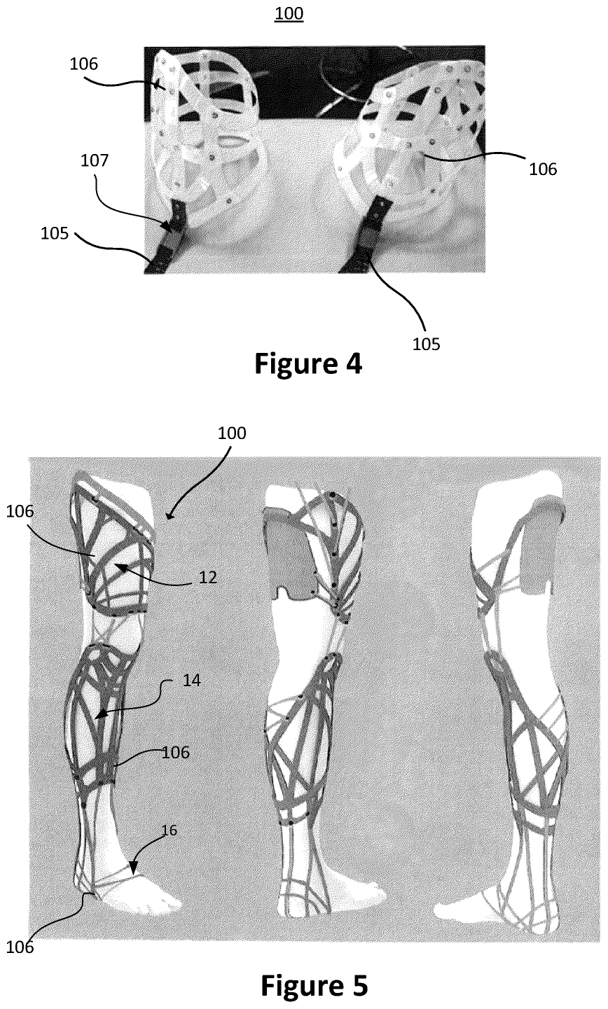

FIGS. 3a-3d depict the body weight support system 100 in accordance with different embodiments of the present invention. The body weight support system 100 comprises leg supports 106 connected to a load bearing structure 200. The leg supports 106 may connect to the load bearing structure 200 via the belt 214 of the hip section 208 or directly to the hip section 208 of the load bearing structure. The edges of the leg supports 106 may comprise a padding 109 for comfort sake. The body weight support system 100 depicted in FIGS. 3a-3d may comprise the leg support system 106 shown in FIG. 4 or FIG. 5.

FIG. 4 depicts in detail a preferred embodiment of the body weight support system 100 where the leg supports 106 are formed of a flexible polymeric material, as described above, forming a network or mesh of interconnected plastic bands molded to fit the thigh of the user. It will be appreciated that although the leg supports 106 are depicted as being molded to fit the thighs of a user, the leg supports may be molded to fit the calf, or foot of the user as illustrated on FIG. 5. As better visible on FIG. 4, to connect to the load bearing structure, the leg supports 106 may comprise connection straps 105 for connecting to the hip section 208 of a load bearing structure. The connection strap may have a snap type connection, a belt type connection, or another connection means. If a belt type connection is used, the leg support 106 may connect to the belt 214 of the load bearing structure with belt connectors, formed of an elastic band followed by a rigid fabric band. If the load bearing structure does not have a belt at the hip section 208, the hip section 208 may be formed to have connections similar to the belt 214 so the leg supports 106 connect directly to the hip section 208.

The connections 105 may have two objectives for the body weight support system:
1) allow the leg supports 106 to be pulled up the leg of the user; and
2) store elastic energy during a stance phase of the gait of the user and to restore the energy to the user during a swing phase of the gait.

The energy is stored in the elastic medium of the system during the loading response and the mid stance of the human gait. After that during the terminal stance of the gait cycle the elastic energy starts to be released to achieve the maximum return during the initial swing phase. This allows to assist the iliotibial band and hip muscles during the swing phase, working in parallel with them. This behavior is the same for the left and the right side. The body wear support system contributes to the decrease of the energetic cost or consumption of locomotion by user.

The connections 105 of the leg supports 106 may comprise a strap type material, such as an elastic band, to store and restore energy to the user, and a mechanism of adjustability 107. Such adjustability may allow for adjustment of the tension of the elastic band, and as such the body weight system can be used with various users and various load bearing structures. The adjustability may be done in the vertical direction, wherein the strap type material can be shortened or lengthened depending on the height of the hip section 208 of the load bearing structure and the placement of the body weight support system 100 on the legs of the user relative to the hip section. This adjustability ensures that the leg supports 106 are being pulled upwards towards the hip section 208 of the load bearing structure 200 so that a portion of the body weight of the user is unloaded during use of the body weight support system 100, and so that the elastic band has a proper tension to store and restore energy to the user.

FIG. 5 depicts another embodiment of a body weight support system 100. The body weight support system 100 comprises leg supports 106 that may fit around the thigh 12, calf 14, and foot 16 of the user 10. It will be appreciated that the leg support system 106 may fit around the thigh 12, calf 14, and foot 16 of the user, or may fit around one or more of the thigh, calf, and foot of the user. The leg support 106 may comprise connection means similar to the connection means, at an outside of the thigh or calf of the leg of the user. If the connection means of the leg support 106 is located at the thigh of the user, the leg support 106 may connect to a hip section 208 or leg section 212 of the load bearing structure 200 to provide the unloading upward force. If the connection means is located at a side of the calf of the user, the leg support 106 may connect to the leg section 212 at a location above the leg support 106 to provide the unloading force.

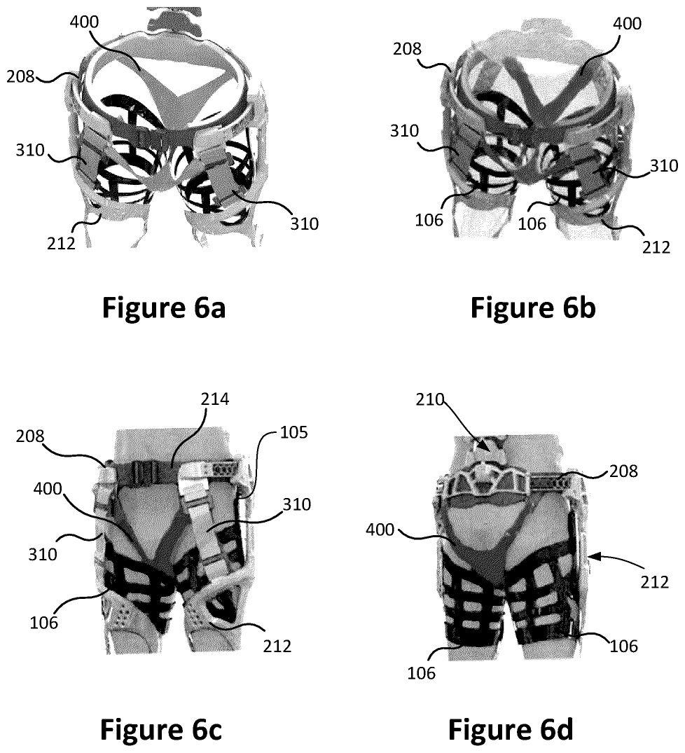

FIGS. 6a-6d depict another embodiment of the body weight support system 100. The body weight support system 100 may comprise leg supports 106 and a passive actuation system 300 comprising elastic mechanisms 310, as described above. The body weight support system 100 further comprises a sacral support 400400 that may be used to unload a portion of the user's body weight by applying an unloading force at the groin and sacral regions of the user. The sacral support 400400 connects to the hip section 208 of a load bearing structure 200 at a front and a back of the user so that the sacral support 400 extends from the front to the back of the user between their legs. The sacral support 400 may connect to a belt 614 of the hip section 208 or directly to the hip section 208 via a connection means of the hip section 208 and the sacral support 400. The connection means of the sacral support 400 may be a snap type connections, a belt type connections, or other type of connections means, similar to the connections described above.

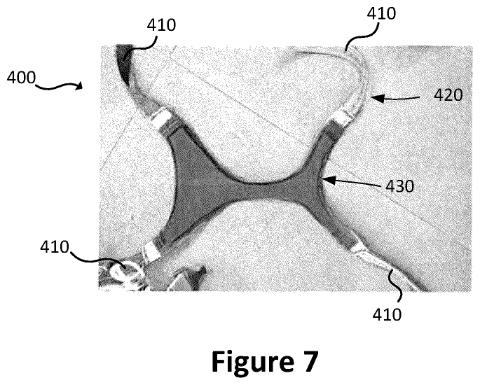

The sacral support 400 may have an elastic nature, and may be composed of a textile material to provide comfort at the groin region of the user. To provide further comfort, the sacral support 400 may comprise a semi elastic part covered with a gel coating at the groin region. The sacral support 400 has an X shape as shown in FIG. 7, where each end of the sacral support 400 comprises connecting elements 410 for connecting to the hip section 208 of the load bearing structure and the centre of the X shape is placed at the groin region of the user. Two of the connections 410 may connect at a front of the user and the remaining two connecting elements 410 may connect at a back of the user. The connecting elements 410, when connected to the hip section 208, are above the centre of the sacral support 400 so that the centre of the sacral support 400 is pulled upwards to provide the unloading force. The X shape of the sacral support 400 may comprise four straps placed in the X shape that have a part formed of elastics (sacral connectors 420) and a part formed of a rigid element (groin connectors 430). It will be appreciated that although the sacral support 400 is depicted as having four ends with a connecting element 410 at each end, the sacral support 400 may have a different shape with more connecting elements 410 or with as little as two connections 410. The connecting elements 410 may further comprise adjustability systems to adjust the length of the straps of the sacral support 400 so that the sacral support 400 is comfortable for the user and properly transfers and supports a portion of the user's body weight.

Alternatively, the sacral support may have the shape and function of panties worn by the user below the exoskeleton, the belt section of the panties being configured to connect with the exoskeleton in a way that the panties apply an unloading/upward force at the groin and sacral regions of the user. Alternatively, a sacral support as the one disclosed herein above can be embedded into a panties to ease the placement of the sacral support.

The sacral support 400 may partially support and transfer the body weight of the user to the ground via the hip section 208 transferring the load to the leg section 612 and then to the ground. The elastic nature and shape of the sacral support 400 may allow the pelvis of the user to be supported during the stance phase of the user's walking cycle, by the load bearing structure. The sacral support 400 may store energy during the stance phase of the user, and return the energy during the push phase of the same leg of the user. This facilitates movement of the user during locomotion.

The body weight support system, in accordance with the present invention, generally comprises the leg support system and optionally the sacral support system, as described above. More preferably, the body weight support system may comprise the leg support system and the sacral support system, and eventually the actuation system, that will work simultaneously during locomotion in order to ease locomotion for the user. It will be appreciated that the body weight support system may comprise one or more of the leg support system, actuation system, and sacral support system and that each system of the body weight support system can be used individually jointly with a load bearing structure. Although the body weight support system is intended and has been depicted as being symmetric in nature, i.e. the right support system and section being a mirror image of the left support system and section, the body weight support system can be implemented with only one of the right or left side.

The body weight support system in accordance with the principles of the present invention may be used for various users, for example, and without limitation, soldiers, police officers (including antiriot and SWAT team personnel), firefighters, construction workers, camera operators, and hikers to assist them in reducing the energy consumed to displace their own bodies when performing bipedal locomotion or other tasks. The body weight support system of the present invention can be used at any speed reached by human beings during locomotion.

When a user wearing the load-bearing structure, to which a body weight support system is attached, is for example, standing, walking, or running, the body weight support system supports and unloads at least part of the body weight of the user, by transferring it to the load bearing structure, which transfers it toward the ground underneath the feet of the user.

In operation, the impact on metabolic cost of the user resulting from the use of the bodyweight support systems is governed by different parameters related both from the human biomechanics and locomotion and/or from the parameter of the bodyweight support system such as the level of unloading forces, tension in elastic mechanisms, weight of each component and/or attachment points of the unloading components.

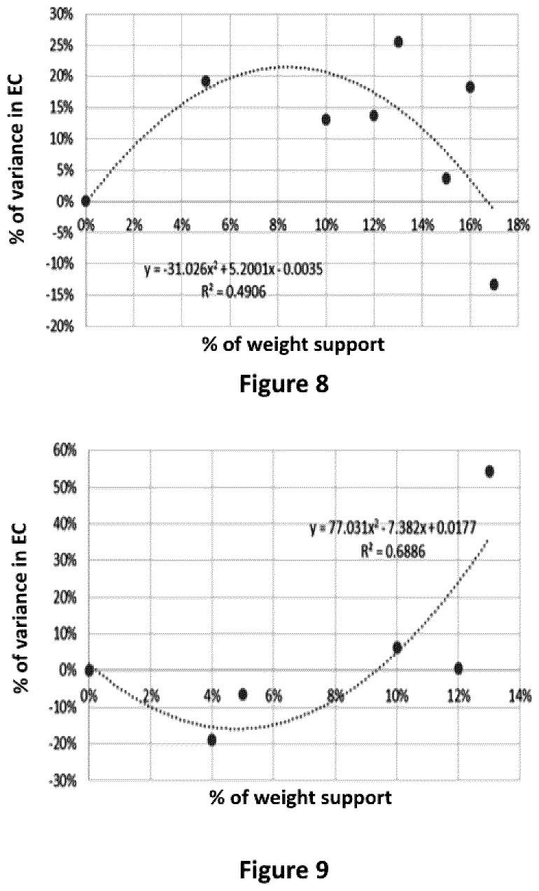

FIG. 8 depicts a relationship between weight supported (% of weigh support) and energetic cost (EC) of locomotion (% of EC baseline) for the leg support system of the body weight support system. The graphical representation depicts the effect of the use of the present invention on oxygen consumption during walking. The graph shows the percentage of the weight support versus the difference (in percentage) of the energy consumption values obtained by the user wearing an exoskeleton only, and the user wearing a leg support system attached to an exoskeleton. The graph further comprises a trend line to represent the data. The exoskeleton used for the graphical data is the exoskeleton as disclosed in in WO 2015/192240 A1, the content of which being incorporated herein by reference. A % of weight support of 100% in the graph means that the leg support system supports 0% of the bodyweight. A trend line (parabola) that best fits the data was determined. A reduction in EC is achieved after 84% on the abscissa (i.e. heading toward left on the graph), which means that a reduction in EC is obtained for support of more than 16% of bodyweight support coming from the leg support system.

Hence, FIG. 8 shows that a reduction of energetic cost of locomotion EC for the user starts occurring when 16% or more of the user's body weight (including the load bearing structure) is borne by the leg support system. It is estimated that that the leg support system could be used to bear as much as 40% of the user's body weight, with results that may vary according to the weight, size and morphology of the user and adjustments to the exoskeleton.

In an embodiment, for a user wearing the exoskeleton of WO 2015/192240 A1 and the leg support system described above, while walking at 4.5 km/h, the oxygen consumption has been reduced by approximately 20% compared to the user walking and wearing only the exoskeleton.

FIG. 9 depicts a relationship between weight support (% of weigh support) and energetic cost of locomotion (% of EC baseline) for the sacral support system. The graphical representation depicts the effect of the use of the present invention on oxygen consumption during walking. The graph shows the percentage of the weight support versus the difference (in percentage) of the energy consumption values obtained by the user wearing an exoskeleton only, and the user wearing a sacral support system attached to an exoskeleton. The graph further comprises a trend line to represent the data. The exoskeleton used for the graphical data is the exoskeleton as disclosed in WO 2015/192240 A1. A % of weight support of 100% in the graph means that the sacral support system supports 0% of the bodyweight.

FIG. 9 shows that, for a user wearing the exoskeleton as disclosed in WO 2015192240 A1 and a sacral support system as described above, a reduction in EC compared to the baseline case, with user wearing only the exoskeleton, is observed when the sacral support system supports between approximately 0% and 8% of the user's bodyweight (with a maximum near 5%), where a reduction exceeding 15% of EC is achieved. It is to be appreciated that results shall vary according to the weight, size and morphology of the user and adjustments to the exoskeleton.

The graphical data, with respect to FIGS. 8 and 9, was realized using an oxygen consumption measuring system (for example, Cosmed™ K5). Such a system includes sensors to measure oxygen and carbon dioxide in the user's exhaled air. The device's software allows for the calculation of the volume of oxygen (O₂) consumed by the user (in millilitres of oxygen or O₂ consumed every minute, normalized by the user's weight or the user's weight plus the weight of the exoskeleton).

The energetic cost for locomotion can be calculated using equation (1):

$$EC = \frac{{V O}_{2 ss} - {V O}_{2 rest}}{speed} ( \frac{J}{Kg * m} )$$

where:
EC is the energetic cost for locomotion of the user;
VO_{2 ss} is the oxygen consumption at a “Steady State” (collected 10 minutes after each 3 minute walk);
VO_{2 rest} is the oxygen consumption when “resting” (collected after 5 minutes of rest and for a duration of 2 minutes); and
speed is the walking speed of the user.

The energetic cost for locomotion can be calculated for various users using a load bearing structure or a load bearing structure and a body weight support system. A net metabolic consumption mainly due to walking of the user is calculated using the top of equation (1), shown as equation (2):

VO_{2 net}=VO_{2 ss}−VO_{2 rest}

where VO_{2 net} is the net metabolic consumption mainly due to walking of the user.

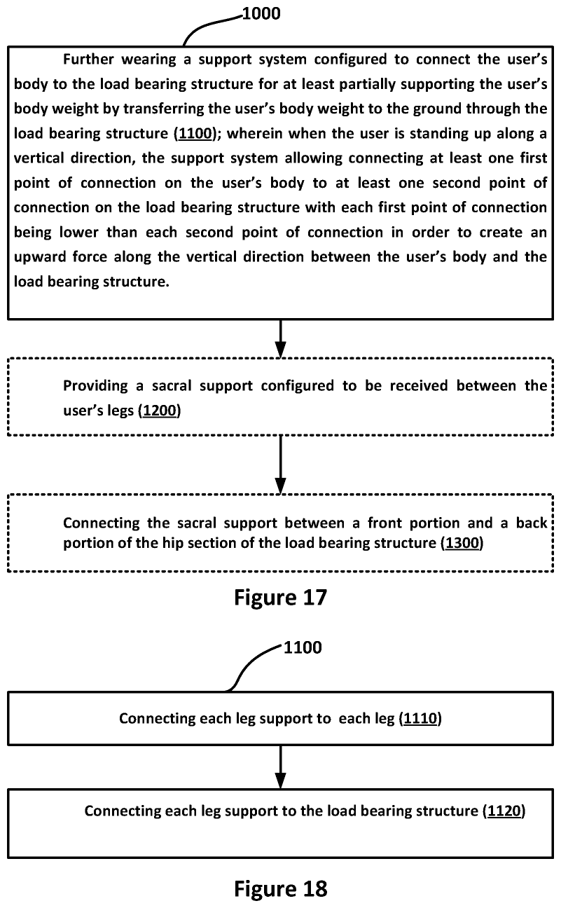

FIG. 17 illustrates the method (1000) as disclosed herein for reducing an energetic cost of locomotion of a user wearing a load bearing structure, such as an exoskeleton, configured to assist the user in carrying a load by transferring the load down to the ground. The method comprises the step (1100) of further wearing a support system configured to connect the user's body to the load bearing structure for at least partially supporting the user's body weight by transferring the user's body weight to the ground through the load bearing structure. As aforesaid, when the user is standing up along a vertical direction, the support system allowing connecting at least one first point of connection on the user's body to at least one second point of connection on the load bearing structure with each first point of connection being lower than each second point of connection in order to create an upward force along the vertical direction between the user's body and the load bearing structure.

According to a preferred embodiment of the method (1000) illustrated on FIG. 18, the support system may comprises a pair of leg supports, each leg support being configured for being connected to one of the legs of the user. The step (1100) of the method (1000) may the comprise the steps:
connecting each leg support to each leg (1110); and
connecting each leg support to the load bearing structure (1120).

According to a preferred embodiment, connecting each leg support to each leg (1110) may comprise the step of providing the first point of connection with the foot, the calf or the thigh of the leg. As shown on FIG. 5, connecting each leg support to each leg (1110) may also comprise the step of providing a plurality of said first point of connection along the legs with the foot (16), the calf (14) and the thigh (12) of the leg.

According to a preferred embodiment, each leg support (106) may connected to the hip section of the load bearing structure with a connecting strap, the method (1000) further comprising: adjusting a length of the strap in order to adjust said tension between the leg and the hip section.

According to a preferred embodiment, connecting each leg of the user (1110) comprises at least partially wrapping each leg support around one of the user's leg.

According to a preferred embodiment, the support system comprises an elastic medium, the method (1000) further comprising storing potential energy during a loading response and a mid stance of a human gait.

According to a preferred embodiment as the one illustrated on FIG. 17, the method (1000) further comprises:
providing a sacral support configured to be received between the user's legs (1200); and
connecting the sacral support between a front portion and a back portion of the hip section of the load bearing structure (1300).

Preferably, the sacral support may be connected to the hip section at two connection locations of the front portion and at two connection locations of the back portion of the hip section.

According to a preferred embodiment, the load bearing structure, such as the exoskeleton, comprises a leg section operatively connected to the hip section, the method (1000) may then further comprise: connecting the leg section to the hip section of the load bearing structure with at least one elastic mechanism, such as an elastic strap in order to store energy during different gait phases of the user.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

What is claimed is:

1. A support system for supporting a body weight of a user configured to be attached to a load bearing structure worn by the user to assist the user in carrying a load by transferring the load down to the ground, the support system being configured to connect the user's body to the load bearing structure for at least partially supporting the user's body weight by transferring the user's body weight to the ground through the load bearing structure, wherein when the user is standing up along a vertical direction, the support system connects at least one first point of connection on the user's body to at least one second point of connection on the load bearing structure, with each first point of connection being lower than each second point of connection in order to create an upward force along the vertical direction between the user's body and the load bearing structure for reducing an energetic cost of locomotion of the user wearing the load bearing structure.

2. The support system of claim 1, wherein the load bearing structure is an exoskeleton comprising at least a hip section operatively connected to a leg section, the support system comprising:
at least one leg support configured to connect a leg of the user with the hip section of the load bearing structure.

3. The support system of claim 2, comprising:
a pair of said at least one leg support, each leg support connecting one of the legs of the user to the hip section of the load bearing structure.

4. The support system of claim 2, wherein each leg support is configured to provide the first point of connection with the foot, the calf or the thigh of the leg.

5. The support system of claim 2, wherein each leg support is configured to provide a plurality of said first point of connection with the foot, the calf and/or the thigh of the leg.

6. The support system of claim 2, wherein each of the leg supports comprises a supporting element configured to be connected to the respective user's leg, and a connecting element extending from the supporting element to connect the supporting element with the load bearing structure.

7. The support system of claim 6, wherein the connecting element comprises a connecting strap having an adjustable length.

8. The support system of claim 6, wherein each supporting element comprises a flexible material configured for at least partially wrapping the user's leg for supporting the leg.

9. The support system of claim 6, wherein each of the leg supports comprises a flexible polymeric material.

10. The support system of claim 9, wherein each of the leg supports has a mesh structure made of the flexible polymeric material.

11. The support system of claim 2, further comprising:
a sacral support configured to be received between the user's legs between a front portion and a back portion of the user where the sacral support connects to the load bearing structure.

12. The support system of claim 11, wherein the sacral support connects to the hip section at four connection locations of the hip section.

13. The support system of claim 11, wherein the sacral support connects to the hip section at two connection locations of the front portion and at two connection locations of the back portion of the hip section.

14. The support system of claim 11, wherein the sacral support is removably connected to the load bearing structure.

15. The support system of claim 11, wherein the sacral support comprises a textile material.

16. The support system of claim 2, further comprising:
at least one elastic mechanism, each elastic mechanism being configured for connecting the leg section to the hip section of the exoskeleton in order to store energy during different gait phases of the user.

17. The support system of claim 16, wherein each of the elastic mechanisms are formed of an elastic strap.

18. The support system of claim 1, wherein the support system comprises an elastic medium for storing potential energy during a loading response and a mid stance of a human gait.

19. A load bearing structure configured to be worn by a user to assist the user in carrying a load by transferring the load down to the ground, wherein the load bearing structure comprises the support system as defined in claim 1 for connecting the user's body to the load bearing structure for at least partially supporting the user's body weight by transferring the user's body weight to the ground through the load bearing structure and as such reducing an energetic cost of locomotion of the user wearing the load bearing structure.

20. The load bearing structure of claim 19, wherein the load bearing structure is an exoskeleton.

21. A method for reducing an energetic cost of locomotion of a user wearing a load bearing structure configured to assist the user in carrying a load by transferring the load down to the ground, the method comprising:
further wearing a support system configured to connect the user's body to the load bearing structure for at least partially supporting the user's body weight by transferring the user's body weight to the ground through the load bearing structure;
wherein when the user is standing up along a vertical direction, the support system allowing connecting at least one first point of connection on the user's body to at least one second point of connection on the load bearing structure with each first point of connection being lower than each second point of connection in order to create an upward force along the vertical direction between the user's body and the load bearing structure.

22. The method of claim 21, wherein the support system comprises a pair of leg supports, each leg support being configured for being connected to one of the legs of the user, the method comprising:
connecting each leg support to each leg; and
connecting each leg support to the load bearing structure.

23. The method of claim 22, wherein connecting each leg support to each leg comprises providing the first point of connection with the foot, the calf or the thigh of the leg.

24. The method of claim 20, wherein connecting each leg support to each leg comprises providing a plurality of said first point of connection with the foot, the calf and/or the thigh of the leg.

25. The method of claim 22, wherein each leg support is connected to the hip section of the load bearing structure with a connecting strap, the method further comprising:
adjusting a length of the strap in order to adjust said tension between the leg and the hip section.

26. The method of claim 22, wherein connecting each leg of the user comprises:
at least partially wrapping each leg support around one of the user's leg.

27. The method of claim 21, wherein the support system comprises an elastic medium, the method further comprising:
storing potential energy during a loading response and a mid stance of a human gait.

28. The method of claim 21, further comprising:
providing a sacral support configured to be received between the user's legs; and connecting the sacral support between a front portion and a back portion of the hip section of the load bearing structure.

29. The method of claim 28, wherein the sacral support is connectable to the hip section at two connection locations of the front portion and at two connection locations of the back portion of the hip section.

30. The method of claim 21, wherein the load bearing structure further comprises a leg section operatively connected to the hip section, the method further comprising:
connecting the leg section to the hip section of the load bearing structure with at least one elastic mechanism in order to store energy during different gait phases of the user.
